(19) United States
(12) Patent Application Publication
(10) Pub. No.: US 2016/0263867 A1
(43) Pub. Date: Sep. 15, 2016

(54) Removable, Plastic Foam Insulation Kits for Architectural Glass

(71) Applicant: Mark Anthony Shippen, Prattville, AL (US)

(72) Inventor: Mark Anthony Shippen, Prattville, AL (US)

(73) Assignee: Mark Shippen

(21) Appl. No.: 15/142,607

(22) Filed: Apr. 29, 2016

Related U.S. Application Data
(62) Division of application No. 14/297,548, filed on Jun. 5, 2014.

(51) Int. Cl. B32B 17/10; B32B 5/18

(52) U.S. Cl. CPC B32B 17/10256; B32B 17/1055; B32B 5/18; B32B 2307/7265; B32B 2255/26; B32B 2307/304; B32B 2266/025

(57) ABSTRACT

A plastic cellular foam (1) with a plastic film (3) laminated to it creates a highly desirable surface for the deposition of numerous adhesives (4). In one embodiment this stock material may be cut easily and double sided tape or transfer tape (7) placed around the periphery (5) to achieve an excellent, glass removable bond. This makes an excellent seal on window glass (9), doors and the like. The observed insulation value can save as much as 83% of heat transferred through the glass. Now, sliding glass doors can be insulated effectively. This invention also provides good light transmission, improves privacy for bedroom glass, creates a display for brilliant artwork, reduces dust accumulations and provides instant removability. The material cuts as easy as paper and will be very simple to fabricate; therefore, this invention can be constructed with simple kits and installed by unskilled, do-it-yourself users.

### FIELD OF INVENTION

Plastic polyolefin heat shrink films are used to reduce winter drafts coming through windows and glass doors. However, these plastic films do not yield significant insulation because there are leaky gaps between movable windows and the tracks of sliding glass doors. Additionally, a ½ inch (12.7 mm) space is required to achieve a 1R insulation value. Plastic olefin films are almost never applied optimally. Also, water vapor can enter through these gaps. Only an impervious seal will yield significant insulation. Masking an air draft is not the same as insulating glass. This new design seals out air and water vapor infiltration by applying glass removable adhesives to a plastic film which is laminated to a plastic cellular foam. This invention will satisfy the long desire of insulating glass to save energy and to add more comfort in homes and other buildings.

This invention has a translucent, plastic cellular foam stock which provides significant insulation, approximately 70% light transmission, and privacy like window blinds or curtains. The user can remove the invention easily and seal it back on the glass when needed. The user can apply the invention partially to a glass window thereby providing dear viewing through some of the glass. This invention will insulate the glass in both summer and winter wherever it is installed. For many applications, the units of this invention will be stackable for easy storage with only the top piece requiring dust protection.

### PRIOR ART

Shippen (U.S. Pat. No. 5,108,811), this inventor, specifies a reusable adhesive applied to polyethylene foam for window insulation. However, this design can leave residue on the glass when installed for months. Another problem was adhesive separation from the inert foam. Furthermore, the foam appears to have a spotted, wet look from an outside, street view of the window. In contrast, the current invention specifies a film laminated on a foam stock. The best lamination films provide a smooth surface to apply double sided tapes. Thereby, glass removability of the tape and release of the insulating article is achieved. The best adhesives give this invention a very minimal adhesive profile when adhered to glass. This eliminates adhesive separation and residual adhesive deposited on the glass. This invention has a dry look when viewed from the outside. For the casual street observer, window applications with this new invention will be difficult to differentiate from a closed blind.

### EMBODIMENTS

The base material is a plastic cellular foam (1). Olefin foams like polyethylene or polypropylene are available commercially and are desired. A polyvinyl chloride foam can be specified if an opaque material is required. However, polyethylene foam is the least costly and the most commonly available. When a ¼ (6.35 mm) foam thickness is specified, up to 83% glass heat transfer savings can be realized. Foams can be manufactured with colored dyes, formulated with antistatic properties, formed with different densities or expanded to various cell dimensions. See FIGS. 1-5. This plastic foam may be included as a flexible sheet material in a kit combination.

Another embodiment is a strong, permanent adhesive (2) applied on one side of the stock foam or one side of the plastic film to effect lamination. Acrylic adhesives can be deposited on the foam or film to effect lamination. Also, uv curable, low shrink acrylate polymers can be applied to effect lamination. Silicones or polymeric elastomer compositions can effect lamination. A double sided rubber adhesive can effect lamination for nearly all plastic films. Silicones and rubber adhesives are desirable because these materials are negligible migrators in landfills. Elastomer compositions mixed in two parts to effect lamination or even uv cured can effect lamination. Other rubber polymeric compositions including synthetic rubber and butyl rubber can effect lamination. Hot melt adhesives can effect lamination. However, rubber and acrylic adhesives are available commercially with plastic films, a product which will create a dry process to effect lamination. Many film manufacturers sell lamination films with easily removable, release liners. Therefore, lamination films with silicone, rubber or high tack acrylic including solvent based acrylic adhesive are preferred. See FIGS. 3-5. These lamination films may be included in a kit combination or laminated to the sheet of foam which is included in a kit combination.

Alternately, lamination films commonly available can be utilized with heat to effect lamination. A matte finish is preferred. UV stabilization is preferred. The lamination can be applied in combination to improve the lamination surface strength. See FIGS. 1-3.

Another element of this invention is a plastic film (3) to provide a smooth, flat surface that will carry a glass removable adhesive. Polyester and polyvinyl chloride films are available commercially and are used for film lamination. PVC is available with uv absorbers and colorants, additives that will slow the discoloration of the stock foam and extend the life of the product. PVC films are also available with gloss or matte finishes to improve the reflectivity of the product when viewed in bright sunshine. Low melting lamination films with matte finishes work well and can be uv stabilized. Artwork, graphics and ads can be printed on plastic films with limitless designs for both commercial and residential use. There could be hundreds of plastics films utilized. See FIGS. 1-5. These plastic films may be included in a kit combination.

To finish the product, a glass removable adhesive composition (4) or double sided adhesive tape (7) is applied to the plastic film. Adhesive compositions can be applied to the plastic film with a glass removable specification. Included are latex, acrylates, acrylics, solvent based acrylics, silicones, elastomers, copolymer microspherers, hot melts, uv curable resins, uv curable elastomers, transfers (including hand wound), repositionables, differential tacks or the like. See FIGS. 2, 3, 5, 6. These adhesive tapes may be included in a kit combination.

In contrast, a glass removable tape can be applied directly to the structural glass as a means to mount the insulating article. A permanent single sided tape like a polyester type or the like can be applied on the periphery of the insulating article to make a desirable release surface for easy separation from the glass removable adhesive. This modification will yield non tacky, insulation articles to be stored easily, especially when removed frequently. While the tape sticks to the glass, the window will open. When the tape fails after extensive use, the glass removable adhesive tape can be stripped off.

Ideally, a double sided glass removable adhesive tape applied to the insulating article is preferred. Double sided tapes ranging up to 100 ounces stainless steel peel per square inch (30N/25 mm) can be used effectively. Naturally, differential adhesive tapes or transfer tapes that are commonly described as removable or repositionable can be specified for this invention. To achieve the desired adhesion between the insulation and glass, double sided tapes such as silicones or acrylics work well. Differential acrylics and transfer tapes work well. Silicone adhesive has an advantage because of its resistance to moisture from condensation; it may be prudent, however, to break a silicone adhesive seal once a year to prevent adhesive freeze and then reapply the article again. Consideration of how easy a release film is removed from the double sided adhesive tape needs to made so that unskilled users can fabricate the invention with ease. A sharp tack, needle, pin or the like is useful to lift the adhesive liner from the adhesive tape to achieve a quick, clean release of the liner.

Conveniently, double sided adhesive tape can be applied primarily to the borders of the plastic laminated film overlapping the tape (5) at the vertices of the insulation article. A ½ inch (12.7 mm) wide tape applied like this makes only a small, sticky adhesive profile that is easy to adhere to glass and to remove from glass. Different widths of the adhesive tape can be specified to achieve a desirable tack and removability of the article. For pieces exceeding one square foot (0.0929 sq. m), placement of nominal sized tape in the middle of the article can secure it flatly to the glass. To make the invention even easier to remove from glass, a small tab can (6) be fabricated easily on each article of insulation. On the last of piece of tape applied to the plastic film, extend the tape approximately ½ inch (12.7 mm) past the edge of the plastic film. Cut it off. Then neutralize the tab with a material such as plastic film or masking tape. See FIG. 6.

When a transfer tape is specified, other types of pull tabs can be used. A nominal piece of release material (10) such as paper can be placed at each vertices to create a lift point for enhanced removal. See FIG. 6. This will help the user to peel back and to remove the insulation article quickly and cleanly. For narrow tapes of ¼ inch (6.35 mm) wide or with mild adhesive compositions, release enhancers may be optional. Another pull type can be made from uv stabilized, clear adhesive film. Also, transfer tapes may be applied in additional layers to extend the article's utility.

The main factors to keep in mind when specifying a glass removable adhesive are air seal, moisture seal, long term pliability and ease of removal. Also, the adhesive chosen for the article should not be fouled in stacks where the adhesive contacts the plastic cellular foam. Polypropylene foam has the smoothest surface. Little plastic cellular material should foul the glass removable adhesive, inhibit or degrade reapplication of the invention to glass. One way to protect all adhesives in storage is to cover the exposed adhesive with the inert side of masking, packing, or regular adhesive tape. Nearly all single sided adhesive tapes have an inert side to make a good, protective liner that will protect the glass removable adhesive from fouling.

### APPLICATIONS

There are many new possibilities for window glass insulation compared to the current art. Half windows can be insulated so that the window can slide open without removal of this invention. Sliding glass doors can slide over the ¼ inch (6.35 mm) insulation with this invention. See FIG. 8. Large windows may be covered with a foam border which reduces the viewing glass space in high energy demand seasons. Spacious, glass windows in government buildings, office high risers and the like can be insulated partially to conserve significant energy. See FIG. 7. Probably, the most common application will be covering an entire glass window to maximize insulation value. See FIG. 9. Since the article of insulation is so easy to cut with ordinary scissors, almost limitless designs can be made. See FIG. 10 for a few simple designs.

Artwork (11) or advertisements can embellish this invention. The dry film side surface makes a great place to add graphics when a double sided adhesive tape is specified. Printing of colorful ads and graphics on the film is anticipated. A foam side surface is always useful to attach graphics. Static ding vinyl decorations, decals and marker drawings may be applied to either the film or foam side. Translucent papers such as tracing or vellum create colorful, spectacular effects when magic markers, chalk or colored pencils are used with this invention. Moreover, cellophane can be mounted with transparent adhesive tape on these articles. Cellophane film is almost as inexpensive as paper. Cellophane can be laminated to remove wrinkles and improve its workability. Clear contact paper makes an excellent lamination film for the cellophane. Also, transparent, colored printing on plastic films can simulate stained glass windows. Commercially available, premium, printed plastics such as vinyl are used to colorize and to simulate stained glass windows, but have no insulation value. Films like these can be laminated to the plastic cellular foam to create excellent visual effects. Furthermore, these premium films can be sized, affixed or printed on the plastic film of this invention to achieve similar visual effects. Therefore, many types of artwork will create a beautiful synergism for these insulation articles. For one example—See FIG. 11. Decorative films may be included in a kit combination.

### DRAWINGS

FIG. 1 Sectional view of plastic film (3) heat laminated to cellular plastic foam (1).

FIG. 2 Sectional view of glass removable adhesive (4) applied to plastic film (3) and heat laminated to plastic cellular foam (1).

FIG. 3 Sectional view of combined heat laminated and adhesive laminated construction.

FIG. 4 Sectional view of permanent adhesive (2) laminated plastic film (3) to plastic cellular foam (1).

FIG. 5 Sectional view of insulation article topped with glass removable adhesive (4).

FIG. 6 Bottom view of applied double sided tape (7) overlapping at vertices (5) with pull tab (6) and release enhancers (10) all applied to plastic film (3).

FIG. 7 Inside view of partially insulated window with a pull tab (6) mounted on uninsulated glass (9).

FIG. 8 Inside view of nearly covered sliding glass door with plastic cellular foam (1) uninsulated glass (9) with structural member (8).

FIG. 9 Inside view of maximum covered window showing plastic cellular foam (1) and a structural frame member (8).

FIG. 10 Front view of some examples of partial insulation coverage designs.

FIG. 11 Front view of artwork (11) attached to plastic cellular foam (1).

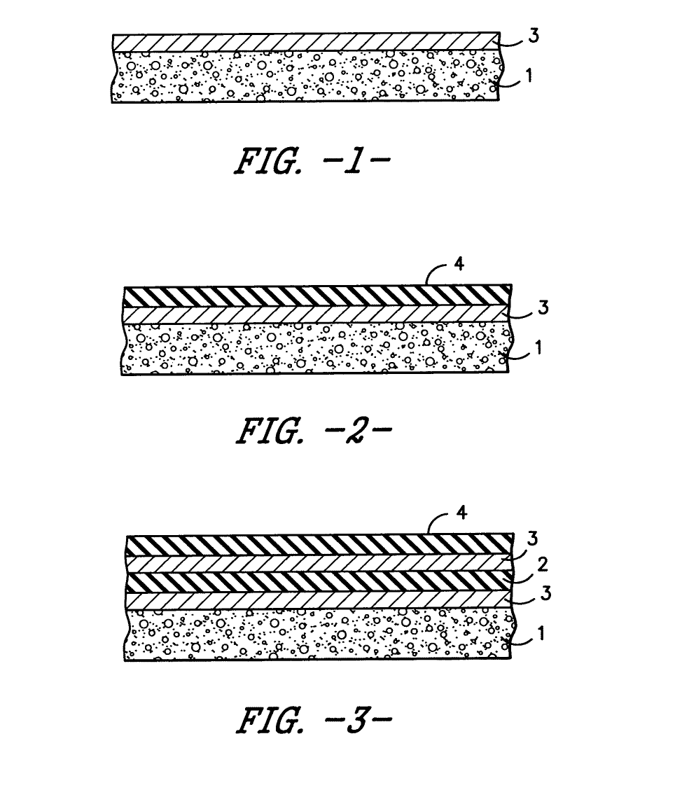

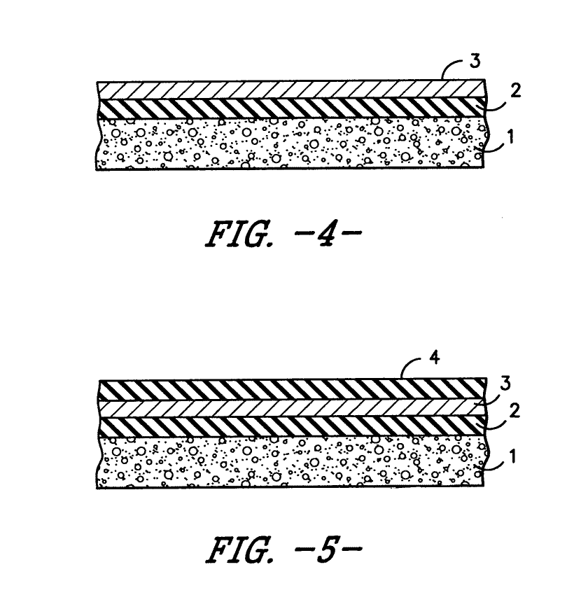

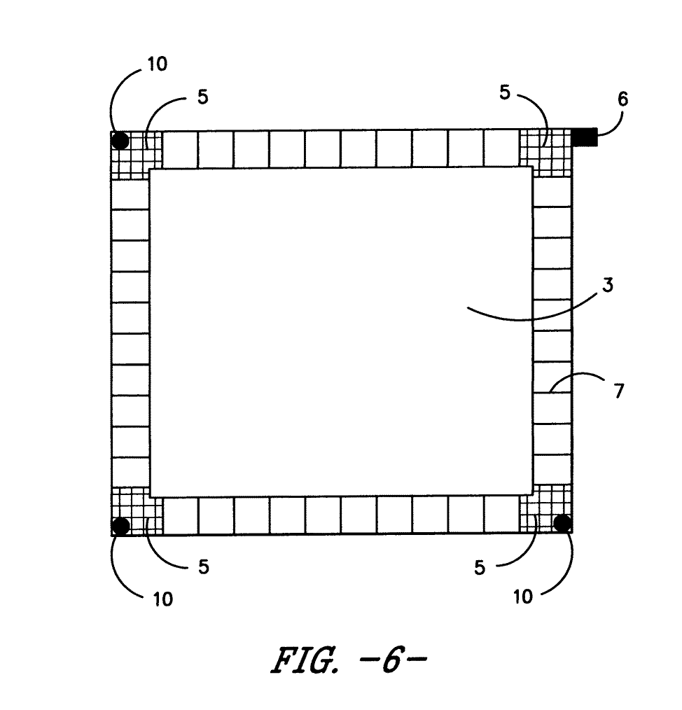

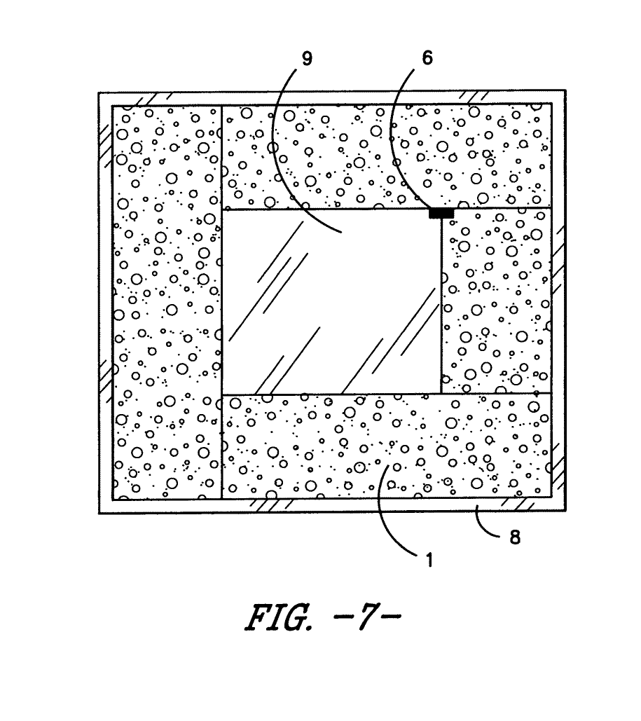

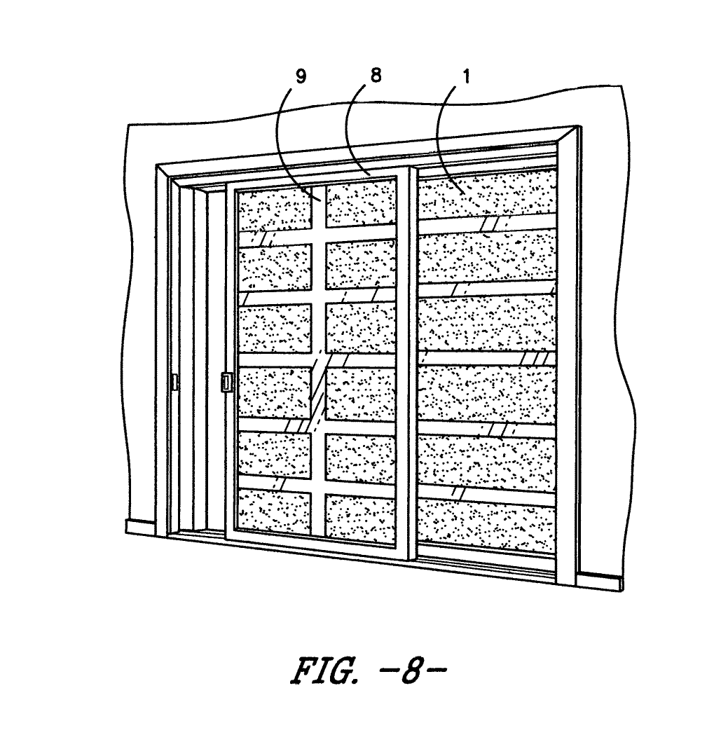

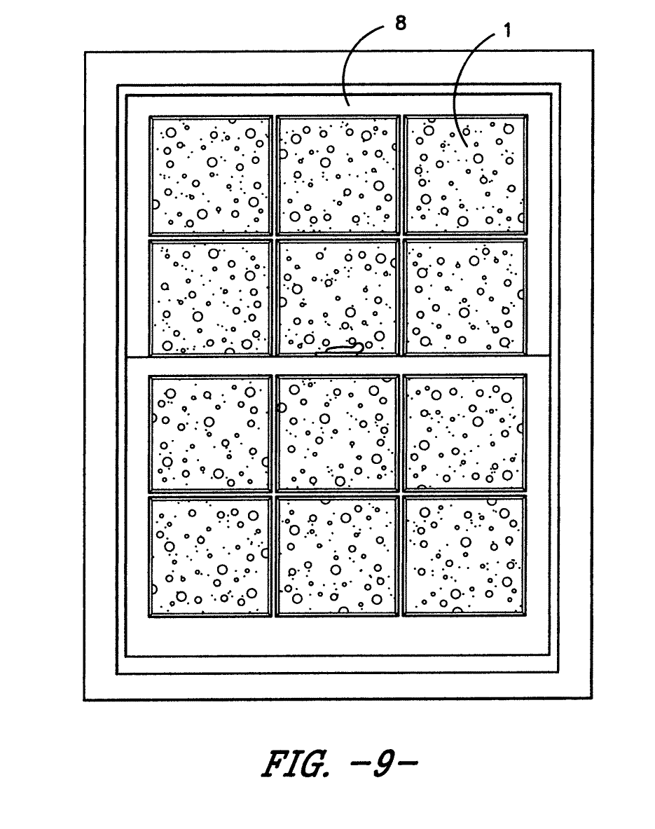

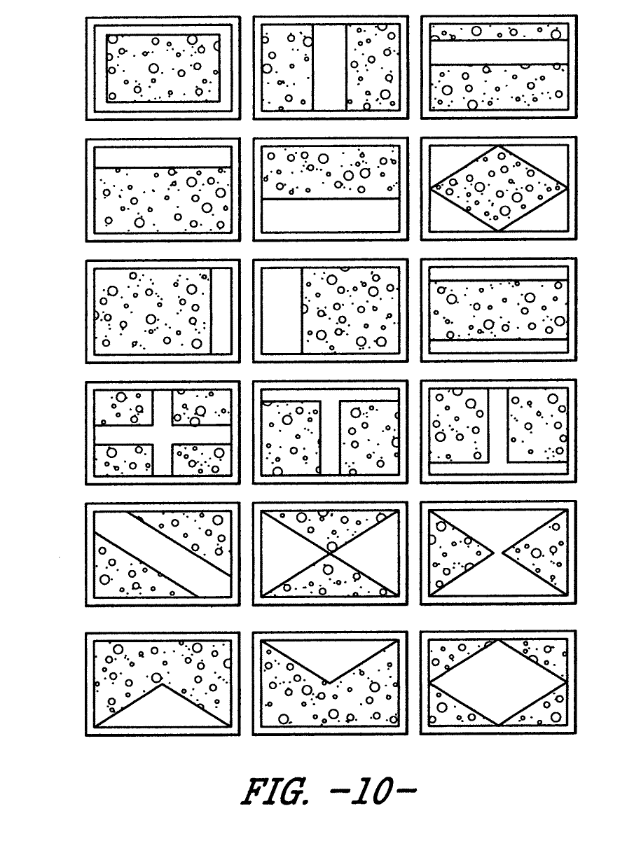

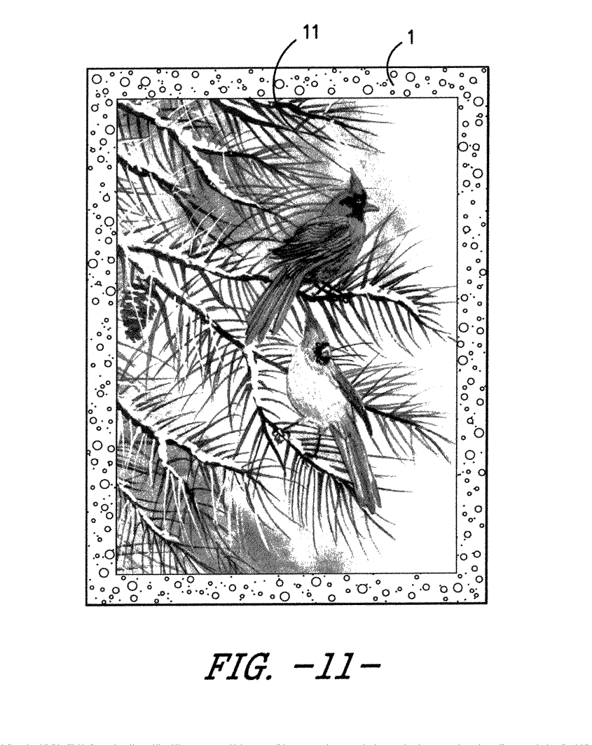

### EXAMPLE ONE

A mobile home near Montgomery, Ala. (USA) with high window condensation was fitted with approximately 60% glass window coverage on single glaze windows. The adhesive was a ½ inch (12.7 mm) wide double sided acrylic tape placed around the periphery of the foam, and the polyethylene foam was ¼ inch (6.35 mm) thick. The retail price of the invention was $150. The annual electricity savings was $409. Wintertime propane savings was $350. The annual return on the investment was 500%. Furthermore, the invention is estimated to last three years before condensation damage. The overall return on the 3 year investment is estimated at $2277. This 3 year savings exceeds 15 times the initial investment. However, reapplication of new adhesive is possible. Additionally, more moisture resistant adhesives are now known. Therefore, this example should be considered illustrative, but not limiting.

### EXAMPLE TWO

An approximately 2500 square foot (233 sq. m) home with double pane windows in Prattville, Ala. (USA) was fitted with 45% coverage in a low condensation environment for a retail cost of $200. The glass removable adhesive on the laminated film was a full application of acrylic material which is rated to remain useable for ten years, and the polyethylene foam was ¼ inch (6.35 mm) thick. The yearly electricity savings was $548. The yearly propane savings calculated was $300. The annual return was 4.2 times the initial outlay. The ten year return on the investment is an estimated $8480. This ten year savings exceeds 42 times the initial investment not including energy inflation.

Finally, this invention could save many lives lost in home fires due to the desperate use of space heaters in cold extremes. It will also relieve the stress on electrical heaters reducing fires from their overuse. Undoubtedly, a thirty to sixty percent reduction of the heating load in a domicile will save many lives. Less pollution benefits countless people across the Earth, reduces collateral water pollution, improves the condition of our biosphere and cleans the air we all breathe.

I claim:

1) A kit for the thermal insulation of architectural glass comprising:
a) at least one plastic film laminated to
a flexible sheet of thermal insulating plastic foam and
b) a double sided adhesive tape with at least one side removable from glass.

2) The combination of claim 1 wherein the flexible sheet of thermal insulating, plastic foam is chosen from the group including polyethylene foam or polypropylene foam.

3) The kit combination of claim 1 wherein the flexible sheet of thermal insulating plastic foam has a thickness approximately ¼ to ⅜ inch.

4) The kit combination of claim 1 wherein the flexible sheet of thermal insulating plastic foam comprises at least one plastic, low melting lamination film.

5) The kit combination of claim 1 wherein the flexible sheet of thermal insulating plastic foam comprises at least one plastic, adhesive lamination film.

6) The kit combination of claim 1 wherein the double sided adhesive tape with at least one side removable from glass is moisture resistant.

7) The kit combination of claim 1 wherein the double sided adhesive tape with at least one side removable from glass is chosen from the group including acrylic, solvent acrylic, silicone, transfer and differential.

8) The kit combination of claim 1 wherein the double sided adhesive tape with at least one side removable from glass has a width approximately ⅛ to ½ inch.

9) The kit combination of claim 1 further including at least one decorative film chosen from the group including vinyl film, printed film, graphic film and transparent colored film.

10) The kit combination of claim 1 further including a least one additional lamination film.

11) The kit combination of claim 1 further including release enhancing pull tabs.

12) A kit for the thermal insulation of architectural glass comprising:
a) a flexible sheet of thermal insulating plastic foam and
b) at least one adhesive lamination film.

13) The kit combination of claim 12 wherein the flexible sheet of thermal insulating plastic foam is chosen from the group including polyethylene foam and polypropylene foam.

14) The kit combination of claim 12 wherein the flexible sheet of thermal insulating plastic foam has a thickness approximately ¼ to ⅜ inch.

15) The kit combination of claim 12 wherein the adhesive laminating film comprises an adhesive removable from glass deposited on a least part of the adhesive laminating film.

16) The kit combination of claim 12 further including a double sided adhesive tape with at least one side removable from glass is chosen from the group including acrylic, solvent acrylic, silicone, transfer and differential.

17) The kit combination of claim 12 further including release enhancing pull tabs.

18) The kit combination of claim 12 further including at least one decorative film chosen from the group including vinyl film, printed film, graphic film and transparent colored film.
